(19) United States
(12) Patent Application Publication
(10) Pub. No.: US 2008/0093093 A1
(43) Pub. Date: Apr. 24, 2008

(54) Combination Hydraulic Hold-Down and Lift System for an Agricultural Implement

(75) Inventors: Clint W. Sheppard, Yorkton (CA); John A. Lesanko, Sturgis (CA); David A. Dobson, Yorkton (CA)

Correspondence Address: HOVEY WILLIAMS LLP, 10801 Mastin Blvd., Suite 1000, Overland Park, KS, 66210, US

(73) Assignee: MORRIS INDUSTRIES LTD, Yorkton (CA)

(21) Appl. No.: 11/876,448

(22) Filed: Oct. 22, 2007

Related U.S. Application Data
(60) Provisional application No. 60/862,724, filed on Oct. 24, 2006.

(51) Int. Cl. A01B 63/10

(52) U.S. Cl. 172/2

(57) ABSTRACT

A static hydraulic system provides yieldable hold-down force to the ground-engaging tools of an implement when the system is in its hold-down mode. Alternatively, the system can be operated in a way to lift the tools into an elevated ground-clearing position when placed in the lifting mode. An accumulator and pressure-reducing valve are incorporated into the hydraulic circuit in such a way that the system need not be an active hydraulic system in which a pump on the tractor would continuously circulate pressurized fluid in the system during ground-engaging operations in the hold-down mode.

### TECHNICAL FIELD

The present invention relates to the field of hydraulic control systems for ground-engaging tools of a farm implement and, more particularly, to a system that can apply a yieldable hold-down force against the tools of the implement or, alternatively, a lifting force for raising the tools off the ground for transport or for turns at the end of a field.

### BACKGROUND AND SUMMARY OF THE INVENTION

Farm implements that employ ground-engaging tools usually need the ability to raise and lower the tools relative to a supporting frame between ground-engaging and elevated positions. Additionally, it is helpful for the tools to be yieldably biased downwardly when in their ground-engaging positions so that each tool can rise and fall as necessary to accommodate changes in ground contour experienced by that particular tool. If the tools employ a ground-penetrating shank or the like, it is also desirable for the shank to be cushioned so that if the shank strikes a rock or other obstacle, the shank can yield rearwardly and upwardly to some predetermined extent as necessary to clear the obstruction without damaging the shank.

The present invention relates to a hydraulic system that combines both the lifting and hold-down functions in a single system. In one mode, the system is operable to provide a yieldable hold-down force against each tool so that the individual tools can rise and fall as necessary to accommodate changes in ground contour encountered by the tool. If the tool employs a ground-penetrating shank, the shank is cushioned so that it can trip upwardly for a limited distance when striking a rock or other obstacle, to avoid damaging the shank. In another mode, the system is operable to simultaneously lift all tools of the implement off the ground and into their raised positions wherein ground clearance is adequate to permit the machine to be turned around in the field or otherwise maneuvered without the tools touching the ground.

In a particularly preferred embodiment, the system of the present invention is a “passive” or “static” hydraulic system wherein a main control valve on an agricultural tractor or the like is maintained in a neutral position during a time that the system is in the operating mode with hold-down pressure applied to the tools. When the valve is in its neutral position, the pump and reservoir on a tractor are isolated from the rest of the system with hold-down pressure trapped in the circuit. This is contrasted to a “active” system wherein the tractor valve would normally be held open in the hold-down mode so as to continuously circulate pressurized oil through the circuit and over a pressure relief valve as part of the system.

### BRIEF DESCRIPTION OF THE DRAWINGS

FIG. 1 is a schematic illustration of a combination hydraulic hold-down and lifting system in accordance with the principles of the present invention, the system being shown in its normal operating mode wherein yieldable hold-down force is applied to ground engaging tools of the machine with which the system is utilized;

FIG. 2 is a schematic diagram similar to FIG. 1 but illustrating the system in a charging mode to build up hold-down pressure within the system;

FIG. 3 is a schematic diagram similar to FIGS. 1 and 2 but illustrating the system in a lifting mode for raising the tools off the ground and into an elevated position;

FIG. 4 is a fragmentary isometric view of an exemplary implement with which the system of the present invention may be utilized;

FIG. 5 is a fragmentary vertical cross-sectional view through the implement of FIG. 4 in a longitudinal direction and illustrating the ground-engaging tool of the implement in its lowered, working position;

FIG. 6 is a fragmentary cross-sectional view of the implement similar to FIG. 5 but illustrating how the shank of the tool can trip rearwardly and upwardly to a limited extent when encountering an obstacle in the field; and

FIG. 7 is a fragmentary longitudinal cross-sectional view of the implement showing the tool in its fully raised mode for making turns at the end of the field or for transport.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiment. For example, the present invention has been illustrated in connection with an implement in the form of a hoe-type planter having ground-engaging shanks that open the soil for depositing seeds and/or fertilizer into the ground. However, it will be appreciated that the principles of the present invention may be readily applied to many other types of implements wherein both a yieldable hold-down force is desired in one operating mode of the system and a positive lifting force is desired in another operating mode of the system to raise and hold tools of the implement in an elevated position off the ground.

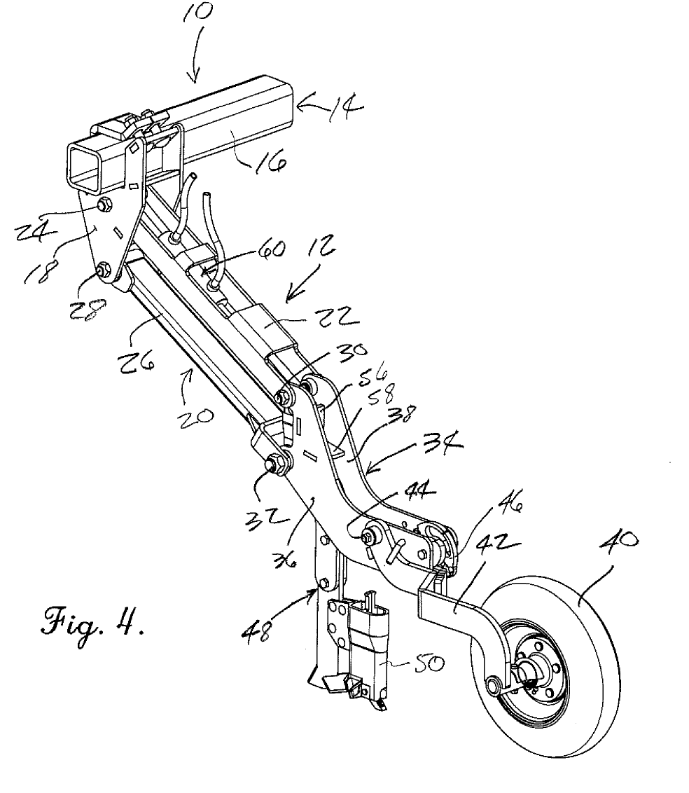

With this disclaimer in mind, attention is first drawn to FIGS. 4-7 illustrating an implement 10 having a plurality of ground-engaging tools 12, only one of such tools 12 being illustrated herein for the sake of simplicity. Among other things, implement 10 includes a frame 14 which may, in a simple form, comprise a transverse tool bar 16. Tool bar 16 could be supported by the three-point hitch of a tractor (not shown) on which implement 10 is mounted, or it could be part of a larger and more complex frame that is supported by ground wheels (not shown) and adapted to be towed behind the tractor.

In any event, it is contemplated that a substantial number of the tools 12 of identical construction will be mounted to the tool bar 16 at spaced locations along the length of the latter so as to extend in a line or row that is transverse to the normal direction of travel of implement 10. Each of the tools 12 includes a mounting bracket 18 for releasably and adjustably securing the tool to tool bar 16.

Each tool 12 further includes a four-bar, parallel linkage 20 that is pivotally attached to bracket 18 for up and down swinging movement relative thereto. Linkage 20 includes a top link 22 attached at its front end to bracket 18 by an upper transverse pivot 24, and a bottom link 26 attached at its front end to bracket 18 by a lower transverse pivot 28. At their rear ends, links 22 and 26 are pivotally attached by upper and lower pivots 30 and 32, respectively, to a downwardly and rearwardly extending arm unit 34 having a pair of laterally spaced apart side plates 36 and 38 that are rigidly interconnected with one another to impart a rigid, unitary construction to the arm unit 34. A packer/depth gauge wheel 40 is adjustably attached to the rear end of arm unit 34 by a wheel arm 42, a transverse pivot 44 at the front end of wheel arm 42, and an adjustment mechanism 46.

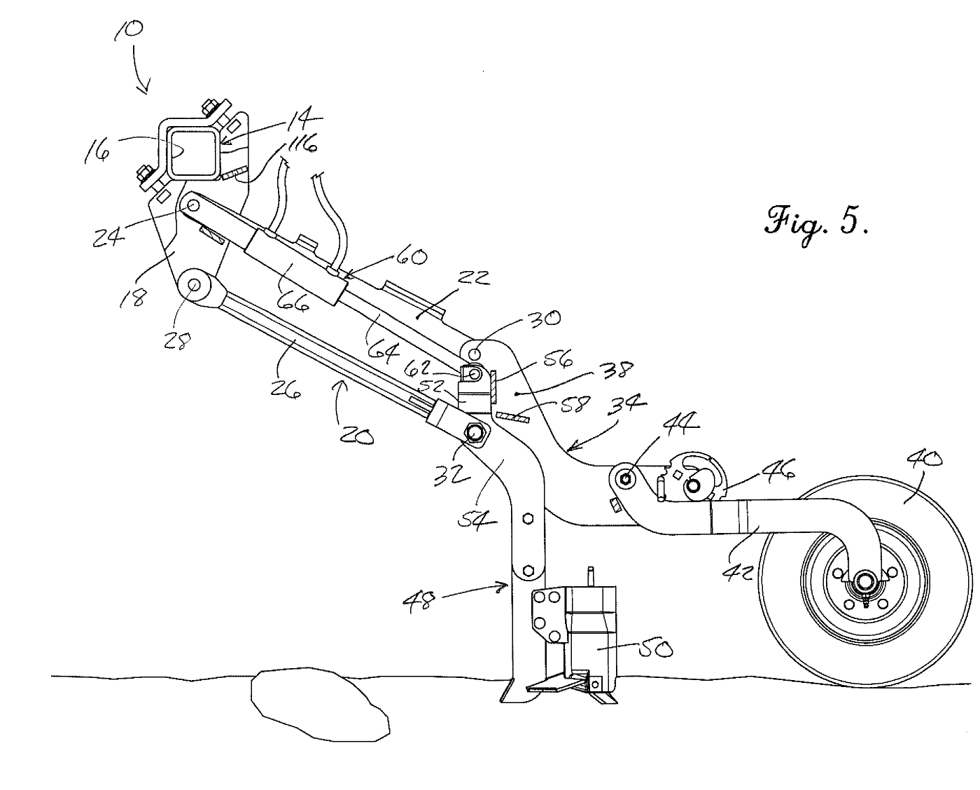

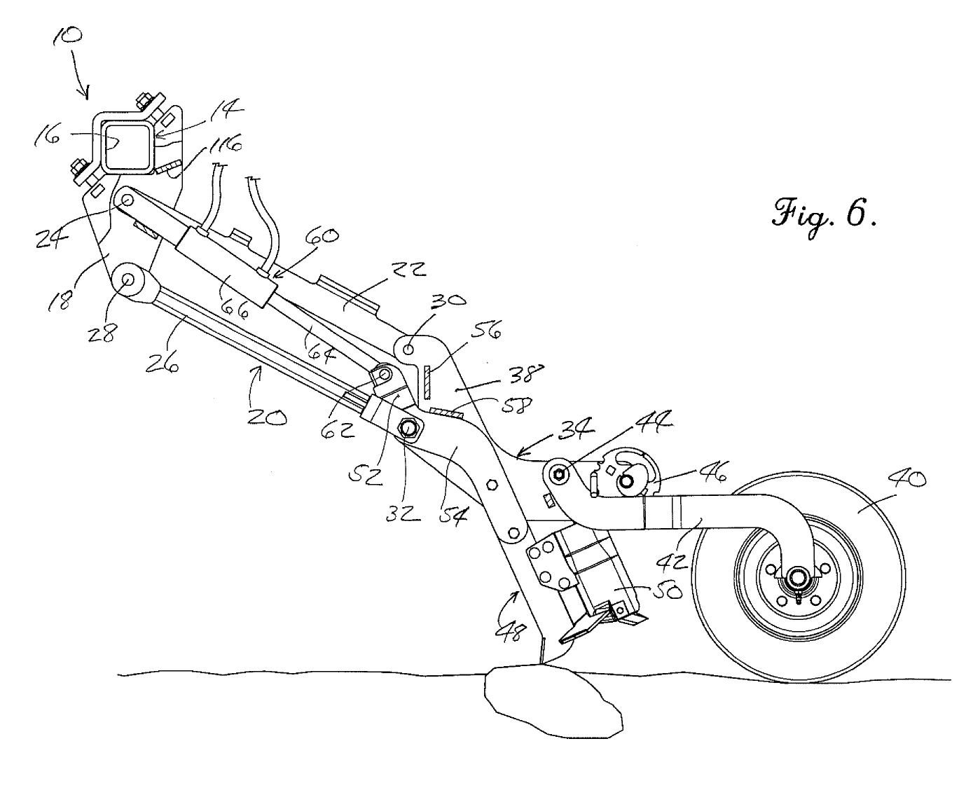

A shank 48 is pivotally attached to arm unit 34 adjacent its front end between the two side plates 36, 38 by the same transverse pivot 32 used to the connect the rear end of bottom link 26 with arm unit 34. In the illustrated embodiment shank 48 is in the nature of a hoe-type opener provided with a boot 50 that may be utilized to deposit both a starter fertilizer and seeds into the ground as shank 48 moves forwardly. Shank 48 has an offset or joggle adjacent its upper end to present an attaching lug 52 above pivot 32 and an intermediate shoulder 54 below pivot 32 but above the lower tip end of shank 48. Shank 48 can swing about pivot 32 to a limited extent between a substantially vertical working position as illustrated in FIG. 5 and a rearwardly angled, tripped position as illustrated in FIG. 6. A transverse limit stop 54 between side plates 36, 38 of arm unit 34 is disposed in the path of rearward travel of lug 52 so as to limit the extent of forward movement of the lower end of shank 48 and thus establish the working position thereof. A second limit stop 56 between side plates 36, 38 is disposed in the path of upward and rearward travel of shoulder 54 to limit the extent of rearward swinging of the lower end of shank 48 about pivot 32 and thereby establish the tripped position of shank 48.

Each of the tools 12 along tool bar 16 is provided with its own double-acting actuator 60. Each actuator 60 has its piston end pivotally connected to bracket 18 by the same transverse pivot 24 utilized to connect top link 22 with bracket 18. The opposite, gland end of each actuator 60 is pivotally connected to the lug 52 of the corresponding shank 48 by a transverse pivot 62. Of course, rod 64 of each actuator 60 is extendable and retractable relative to the cylinder 66 of actuator 60 by hydraulic pressure within cylinder 66 as will hereinafter be explained in more detail. It will also be noted that rod 64 can be temporarily pushed a short distance into cylinder 66 by a mechanical force applied rearwardly against the lower tip of shank 48 to trip the latter, and also by a mechanical force applied upwardly against the packer/depth wheel 40 during rises in the terrain. Alternatively, rod 64 can extend slightly if and when packer/depth wheel 40 drops into a depression in the ground surface.

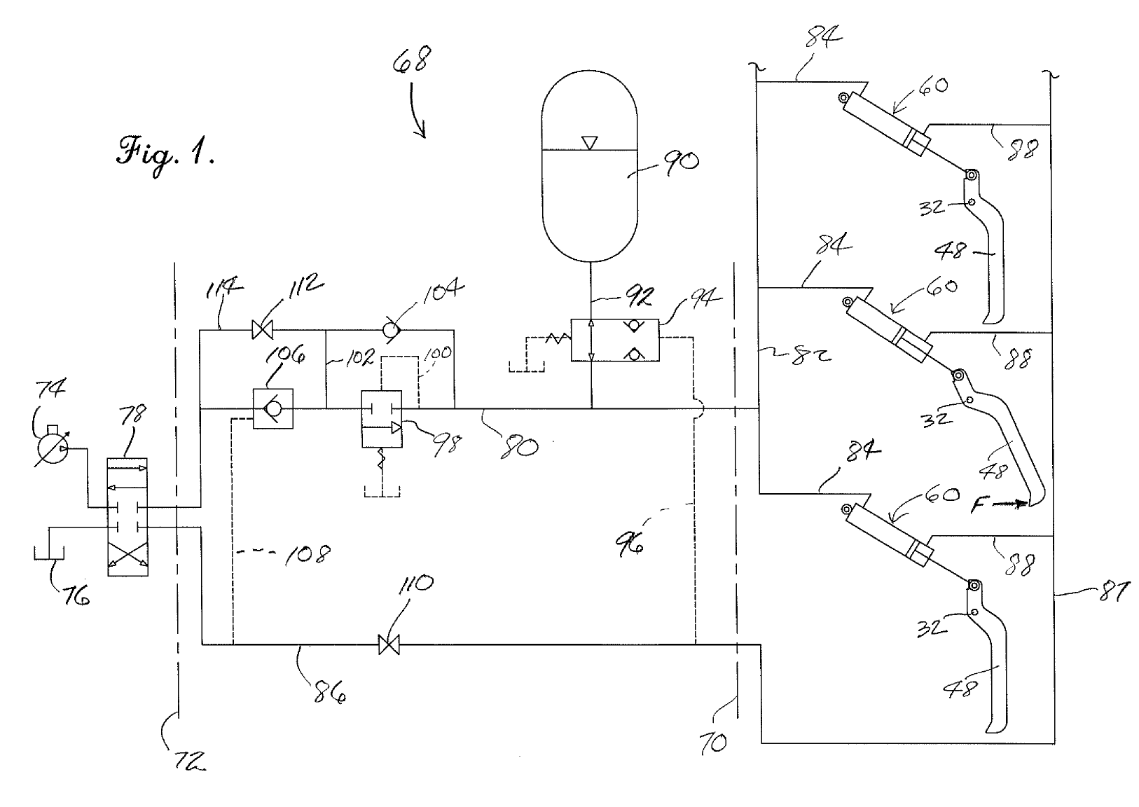

FIGS. 1-3 illustrate a hydraulic combination hold-down and lifting system for the tools 12 of implement 10. It will be appreciated that actuator 60 associated with each tool 12 comprises part of system 68. Those components of system 68 disposed to the right of a phantom line 70 in FIGS. 1-3 are found on the tools 12, while those components to the left of a phantom line 72 in those figures are typically found on the tractor Components disposed between phantom lines 70 and 72 would typically be located on frame 14 of implement 10.

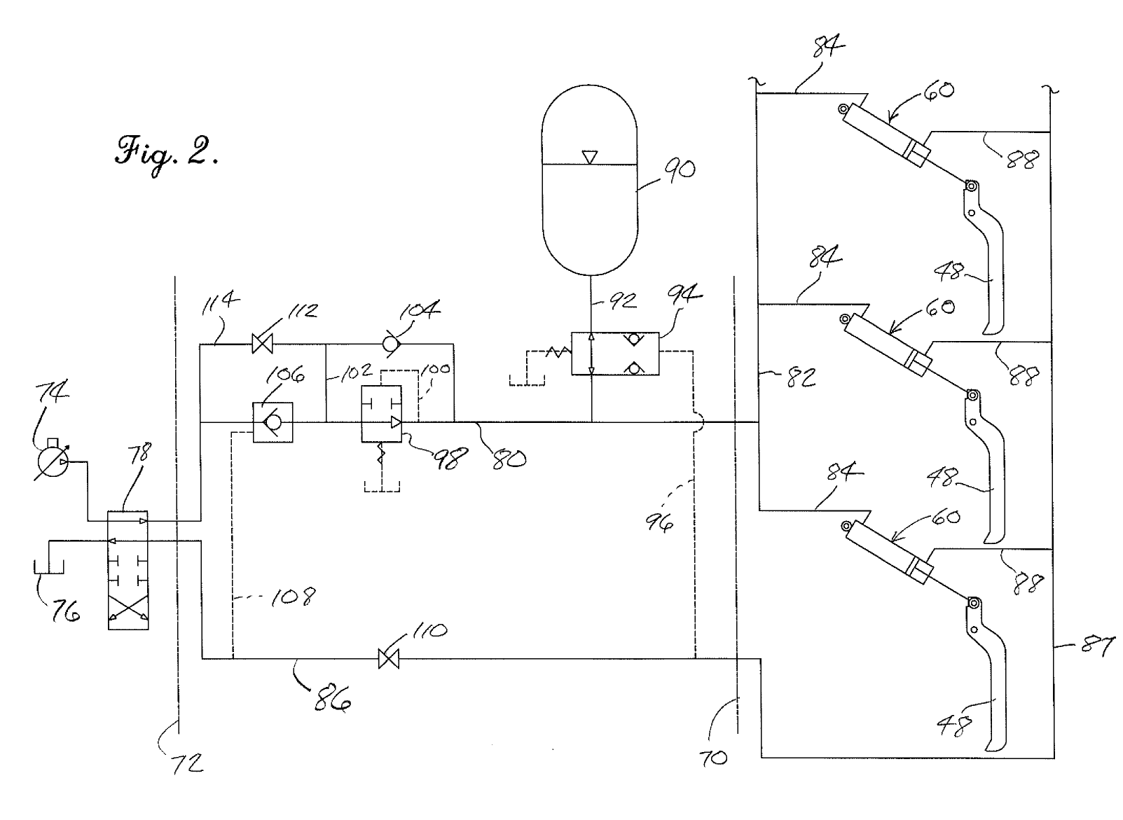

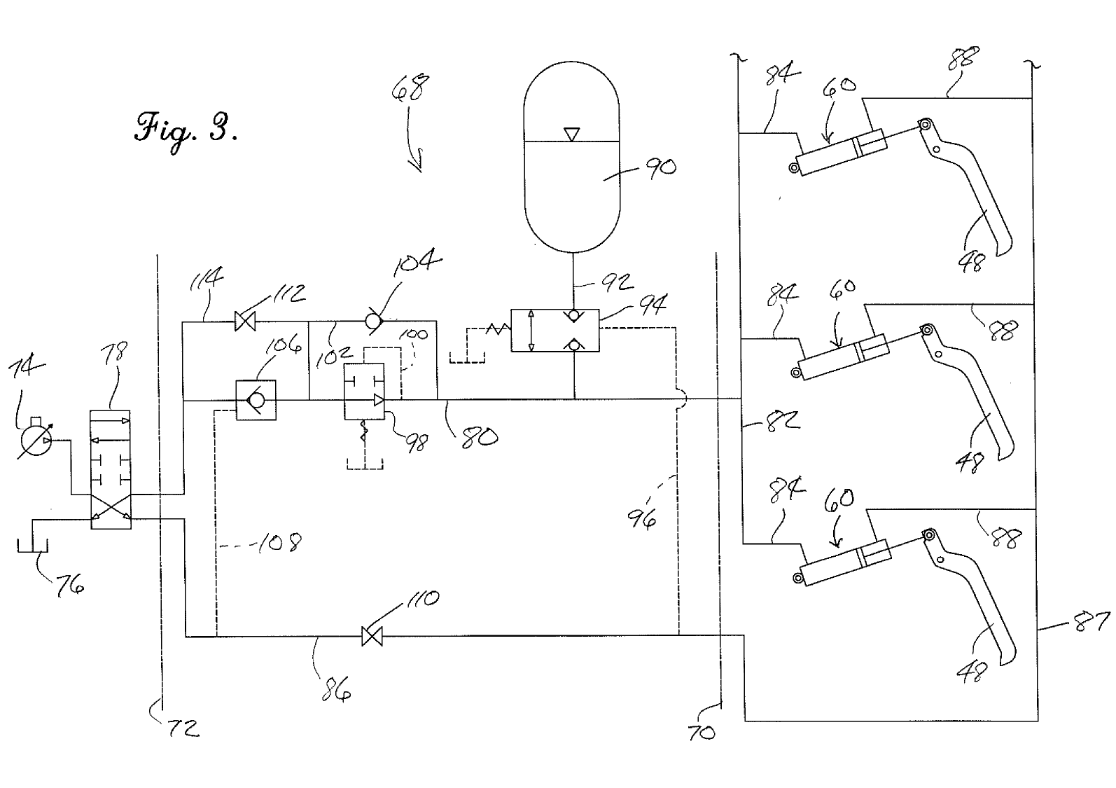

In addition to actuators 60, system 68 includes a pump 74, a reservoir 76, and a three-position spool valve 78. Spool valve 78 is illustrated in its neutral position in FIG. 1, in a charging position for charging the system in FIG. 2, and in a lifting position for lifting tools 12 off the ground in FIG. 3. A hold-down fluid line 80 is connected at one end with spool valve 78 and at its opposite end with the piston side of each actuator 60 via a plurality of branch lines 82 and 84. Lines 80, 82, and 84 thus establish part of a hold-down fluid pressure circuit path within system 68. A lifting line 86 connects at one end with spool valve 78 and at its opposite end with the gland end of each actuator 60 via branch lines 87 and 88. Thus, lines 86, 87, and 88 establish part of a lifting circuit path of the system 68.

It will be noted that all of the actuators 60 are interconnected in a parallel fluid flow relationship, with the piston sides of all actuators 60 connected to hold down line 80 and the gland ends of all actuators 60 connected to lifting line 86. It will be appreciated that any number of actuators 60 may be employed as part of system 68, depending upon the number of tools 12 utilized; thus, the circuit in FIGS. 1-3 is shown for purposes of illustration only as being incomplete in the sense that branch lines 82 and 87 continue on to indefinite termination points in those figures. In actual fact, they terminate at the branch lines 84 and 88 associated with the last actuator 60 on the machine.

System 68 further includes a cushioning accumulator 90 connected to hold-down line 80 by a branch line 92 so as to be in communication with the piston ends of actuators 60. Accumulator 90 may take a variety of different forms but is preferably an oil/gas accumulator wherein the gas phase is separated from the hydraulic oil phase by a flexible membrane or partition. One suitable such accumulator is available from Hydac Corporation of Bethlehem, Pa. as Model SB330.

As an option, accumulator 90 may be provided with a pilot-operated on/off flow control valve 94 located in branch line 92. On/off control valve 94 is normally open so as to dispose accumulator 90 in open communication with hold-down line 80 and the piston sides of actuators 60. On the other hand, valve 94 may be shifted to a closed position isolating accumulator 90 from hold-down line 80 and the piston ends of actuators 60 when lifting line 86 is pressurized. Such pressure may be communicated to valve 94 by a pilot line 96 leading from lifting line 86. On/off control valve 94 is illustrated in its open position in FIGS. 1 and 2 and in its closed position in FIG. 3.

System 68 further includes a pressure-reducing valve 98 in hold-down line 80 between accumulator 90 and valve 78. As will be seen, the function of pressure-reducing valve 98 is to allow pressure within hold-down line 80 to build to a certain predetermined adjustable level during charging of the circuit, but to then close and preclude the flow of fluid past valve 98 toward accumulator 90 and actuators 60. A pilot line 100 communicating with hold-down line 80 between valve 98 and actuator 60 functions to close pressure-reducing valve 98 when the set pressure is reached within hold-down line 80. Valve 98 is shown in its closed position in FIG. 1 and in its open position in FIGS. 2 and 3. One suitable such pressure-reducing valve is available from Command Controls Corporation of Elgin, Ill. as Model #PRPS-10-N-K-8TA-15.

A bypass line 102 around pressure-reducing valve 98 connects at its opposite ends to hold-down line 80 on opposite sides of pressure-reducing valve 98. A check valve 104 in bypass line 102 is operable to close bypass line 102 to fluid flow around pressure-reducing valve 98 in a direction from spool valve 78 toward actuators 60. On the other hand, check valve 104 is disposed to open and permit the flow in the opposite direction around pressure reducing valve 98. Although pressure-reducing valve 98 is operable to open when pressure in hold-down line 80 drops below the selected pressure level such as during lifting of tool 12 to its elevated position, oil normally flows through check valve 104 at such time rather than pressure-reducing valve 98 because check valve 104 has less resistance to fluid flow than pressure-reducing valve 98. This speeds up the process of contracting actuators 60 to lift tools 12. Thus, bypass line 102 and check valve 104 are helpful and desirable parts of system 68, but are not absolutely essential.

System 68 additionally includes a pilot-operated check valve 106 in hold-down line 80 between spool valve 78 and pressure-reducing valve 98. Check valve 106 closes hold-down line 80 against retrograde flow in the direction from pressure-reducing valve 98 back to spool valve 78 but does not restrict flow from spool valve 78 toward pressure-reducing valve 98. A pilot line 108 connects check valve 106 with lifting line 86 in a manner to open check valve 106 when lifting line 86 is pressurized for raising tools 12 out of the ground. Check valve 106 is utilized primarily to prevent leakage past spool valve 78 when spool valve is in the neutral position. In the event that spool valve 78 is of such construction as to avoid the threat of significant leakage, check valve 106 may be eliminated. Thus, while check valve 106 and pilot line 108 are desirable, they are not essential.

System 68 may also include a pair of on/off ball valves 110 and 112. Ball valve 110 is located in lifting line 86 and is normally maintained in an open condition. Once tools 12 have been raised to their fully elevated positions, ball valve 110 may be closed to maintain tools 12 in that position for transport if desired. This takes pressure off the spool valve 78.

Ball valve 112 is disposed in a bypass line 114 around pilot-operated check valve 106 to communicate with hold-down line 80 on opposite sides of pilot-operated check valve 106. Conveniently, bypass line 114 may connect with bypass line 102 between pilot-operated check valve 106 and pressure-reducing valve 98. Ball valve 112 is normally closed. Thus, it has no effect when hold-down line 80 is pressurized to hold tools 12 down against the ground. However, with tools 12 resting on the ground, ball valve 112 may be opened, pump 74 disabled, and spool valve 78 moved to its position of FIG. 3 so as to permit fluid to drain from accumulator 90 and hold-down line 80 back to reservoir 76. This would normally be done during maintenance or repair procedures, not normal operation. Thus, it will be seen that ball valves 110 and 112, as well as bypass line 114, are desirable but not essential parts of system 68.

Operation

In order to lower tools 12 to the ground and apply hold-down force thereto, spool valve 78 is shifted to the lowering mode position of FIG. 2 so as to establish communication between pump 74 and hold-down line 80. Lifting line 86 connects to reservoir 76 at this time. As initial hydraulic flow is applied to pressure-reducing valve 98, it allows fluid flow therethrough and into accumulator 90 and the piston side of actuators 60. Inasmuch as on/off control valve 94 is open at this time, oil flows into accumulator 90 until pressure in hold-down line 80 reaches the set point of pressure-reducing valve 98. At that point, pressure-reducing valve 98 will close and stop any further oil from entering into the accumulator side of the circuit.

During such charging of the accumulator side of the circuit, oil from the gland side of actuators 60 is allowed to return to reservoir 76 through lifting line 86 until the pressure has stabilized at the set point on the piston side of actuators 60 and pressure-reducing valve 98 has closed. Once this occurs, and the tools 12 have engaged the ground, pressure on the gland side of actuators 60 and in lifting line 86 will drop to nearly atmospheric pressure.

System 68 is a passive or static system, as opposed to an active system. Therefore, once tools 12 are fully lowered and the set pressure has been established on the accumulator side of the circuit, spool valve 78 is returned to its neutral, operating position of FIG. 1 to place system 68 in its operating, hold-down mode. In this condition, hold-down line 80 remains pressurized so that, together with accumulator 90, a yieldable hold-down force is applied against all of the tools 12 and their shanks 48. Each of the tools 12 can rise and fall independently of the others due to the parallel fluid flow relationship between actuators 60 and the presence of accumulator 90. Thus, if one packer/depth gauge wheel 40 encounters a rise not experienced by the wheels 40 of the other tools 12, the affected tool 12 may swing upwardly as necessary against the downward bias of the hold-down force in the circuit. Any fluid displaced out of the piston end of the affected tool 12 will either be absorbed by the accumulator 90 or redistributed among the other actuators 60. Likewise, if one of the tools 12 should encounter a low spot, the affected tool can swing momentarily downward as its wheel 40 stays in engagement with the ground. Although such downward movement slightly extends the actuator 60 of the affected tool 12, the displaced volume of fluid is made up for by accumulator 90 and a slight redistribution of fluid from the other, unaffected actuators 60.

Similarly, in the event that the shank 48 of a tool 12 impacts a rock as illustrated in FIG. 6, that shank can trip upwardly and rearwardly until its shoulder 54 engages stop 58. This is also illustrated by one of the shanks 48 in FIG. 1. The shock load imparted to the lower end of shank 48 by the rock is damped and absorbed by accumulator 90 and hydraulic lines 80, 82, and 84.

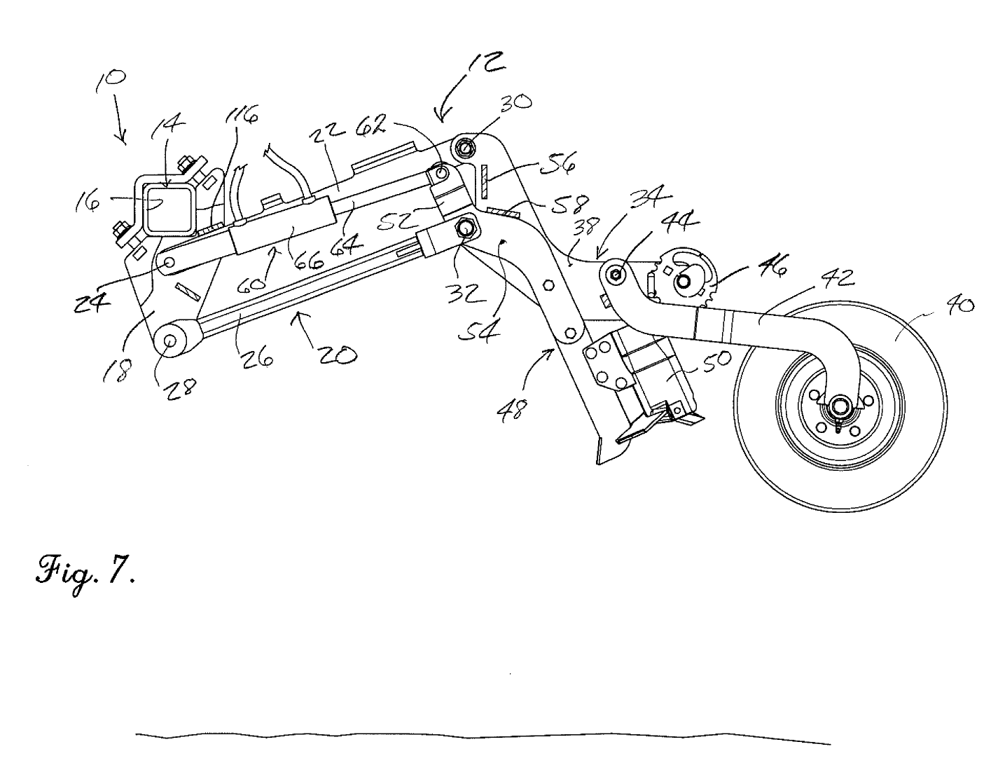

When it is desired to lift tools 12 entirely off the ground to their elevated positions as illustrated in FIG. 7, spool valve 78 is shifted to its lifting position of FIG. 3 to place system 68 in its lifting mode. This places pump 74 in communication with lifting line 86 and places reservoir 76 in communication with hold-down line 80. Consequently, the gland ends of actuators 60 become pressurized, on/off control valve 94 is shifted by pilot line 96 to its closed position, and pilot-operated check valve 106 is opened by pilot line 108. Thus, as actuators 60 begin to contract, oil displaced from the piston ends thereof flows back through hold-down line 80, check valve 104, and pilot-operated check valve 106 to return to reservoir 76.

The first contracting movement of actuators 60 takes up the lost motion in shanks 48 as they are rotated counter-clockwise until their shoulders 54 engage the corresponding stops 58. Thereafter, because actuators 60 have an offset or cranked relationship with respect to the upper link 22 of parallel linkage 20, further contraction of actuators 60 results in parallel linkage 20, and thus the entirety of each tool 12, to be lifted upwardly in a counter-clockwise direction about the pivots 24 and 28. Once all of the tools 12 reach their elevated position of FIG. 7 as determined by the engagement of each top link 22 against a stop 116 associated with bracket 18, spool valve 78 may be returned to its neutral position of FIG. 1, holding tools 12 in their elevated positions until once again lowered. If desired, ball valve 110 may be closed at this time to relieve pressure on spool valve 78 yet hold tools 12 in their elevated positions such as for transport or other purposes.

It will be appreciated that by having control valve 94 closed during the lift mode, accumulator 90 is prevented from fully discharging during this cycle. This decreases the amount of hydraulic fluid that is required to pressurize actuators 60 during the lowering mode of operation, thereby reducing the time required to return system 68 to its normal hold-down mode as in FIG. 1. Although valve 94 has been illustrated as being operated by pilot line 96, it can also be activated by an electric solenoid or other device.

As noted above, control system 68 is a passive or static system as opposed to an active system that requires hydraulic fluid to continuously provide flow against a pressure relief valve in order to maintain pressure to the hydraulic actuators. In an active system, extra oil from the remote outlet on the tractor must be bypassed over a relief valve, which generates excessive heat and can cause damage to tractor hydraulic systems in extreme cases. Moreover, an active system diverts valuable fluid flow capacity from the tractor hydraulic pump, which may be needed for other applications in connection with the implement such as, for example, driving a hydraulic motor connected to a fan for pneumatically distributing seed and fertilizer to ground-engaging elements. Still further, if a leak occurs in an active system, the tractor hydraulic pump will continue to pump oil to the relief valve to maintain actuator pressure, even if oil is continuously being lost to the environment through the leak. This could lead to a major loss of hydraulic fluid, with damaging consequences as a result. On the other hand, in the present invention a leak would be discovered quickly due to a drop in system pressure that could be noted on a gauge associated with the system. The operator could immediately take corrective steps upon noting the pressure drop.

Pressure-reducing valve 98, check valve 104, and pilot-operated check valve 106 have been illustrated and described above as comprising separate components interconnected by multiple hydraulic lines. However, as well understood by those skilled in the art, these components, and perhaps others of system 68 as well, could be integrated into a single valve body or block and simply interconnected with one another via various ports and passages within the block.

The inventors hereby state their intent to rely on the Doctrine of Equivalents to determine and assess the reasonably fair scope of their invention as pertains to any apparatus not materially departing from but outside the literal scope of the invention as set out in the following claims.

1. In combination with a ground-engaging tool mounted on a mobile frame for movement between a lowered, ground-engaging position and a raised, ground-clearing position, a combination hydraulic hold-down and lifting system comprising:
a hydraulic actuator operably coupled with the tool;
a hold-down circuit path connected to one end of the actuator;
a pressure-reducing valve in the hold-down circuit path operable to prevent pressure in the hold-down circuit path from exceeding a predetermined level when the hold-down circuit path is connected to a source of pressurized fluid;
a cushioning accumulator communicating with said hold-down circuit path between the pressure-reducing valve and the actuator for applying a yieldable hold-down force to the tool when the tool is in the lowered position and the hold-down circuit path and the accumulator are pressurized; and
a lifting circuit path connected to the opposite end of the actuator for lifting the tool out of the lowered position to said raised position when the lifting circuit path is connected to a source of pressurized fluid and the hold-down circuit path is connected to a reservoir.

2. The combination as claimed in claim 1,
further comprising a bypass circuit path around the pressure-reducing valve and a check valve in said bypass circuit path,
said check valve being operable to allow flow around the pressure-reducing valve from said one end of the actuator when the lifting circuit path is connected to a source of pressurized fluid and to preclude flow around the pressure-reducing valve in the opposite direction when the hold-down circuit path is connected to a source of pressurized fluid.

3. The combination as claimed in claim 1,
further comprising a pilot-operated check valve in said hold-down circuit path operable to preclude the release of pressure in the hold-down circuit path,
said pilot-operated check valve having a pilot line connecting the same with said lifting circuit path for opening the pilot-operated check valve when the lifting circuit path is connected to a source of pressurized fluid.

4. The combination as claimed in claim 1,
further comprising a pilot-operated flow control valve disposed in an open condition communicating the accumulator with the hold-down circuit path when the hold-down circuit path is pressurized,
said pilot-operated flow control valve having a pilot line connecting the same with said lifting circuit path for closing the pilot-operated flow control valve to block retrograde flow out of the accumulator when the lifting circuit path is connected to a source of pressurized fluid and the hold-down circuit path is connected to a reservoir.

5. The combination as claimed in claim 4,
further comprising a pilot-operated check valve in said hold-down circuit path operable to preclude the release of pressure in the hold-down circuit path,
said pilot-operated check valve having a pilot line connecting the same with said lifting circuit path for opening the pilot-operated check valve when the lifting circuit path is connected to a source of pressurized fluid.

6. The combination as claimed in claim 5,
further comprising a bypass circuit path around the pressure-reducing valve and a check valve in said bypass circuit path,
said check valve being operable to allow flow around the pressure-reducing valve from said one end of the actuator when the lifting circuit path is connected to a source of pressurized fluid and to preclude flow around the pressure-reducing valve in the opposite direction when the hold-down circuit path is connected to a source of pressurized fluid.

7. The combination as claimed in claim 2,
further comprising a pilot-operated check valve in said hold-down circuit path operable to preclude the release of pressure in the hold-down circuit path,
said pilot-operated check valve having a pilot line connecting the same with said lifting circuit path for opening the pilot-operated check valve when the lifting circuit path is connected to a source of pressurized fluid.

8. The combination as claimed in claim 1,
said hydraulic actuator comprising one of a plurality of hydraulic actuators connected in a parallel fluid flow relationship with one another and operably coupled with respective ones of a plurality of tools.
